(19) United States
(12) Patent Application Publication
(10) Pub. No.: US 2025/0365179 A1
(43) Pub. Date: Nov. 27, 2025

(54) METHODS FOR CHANNEL PARAMETER ESTIMATION

(71) Applicant: InterDigital Patent Holdings, Inc., Wilmington, DE (US)

(72) Inventors: Akshay Malhotra, San Jose, CA (US); Satyam Kumar, Austin, TX (US); Shahab Hamidi-Rad, Sunnyvale, CA (US)

(73) Assignee: InterDigital Patent Holdings, Inc., Wilmington, DE (US)

(21) Appl. No.: 19/108,109

(22) PCT Filed: Sep. 22, 2023
(86) PCT No.: PCT/US2023/074876

§ 371 Date: Feb. 28, 2025

Related U.S. Application Data
(60) Provisional application No. 63/408,919, filed on Sep. 22, 2022.
(60) Provisional application No. 63/516,637, filed on Jul. 31, 2023.

(51) Int. Cl. H04L 25/02

(52) U.S. Cl. CPC H04L 25/0254; H04L 25/0214; H04L 25/0216

(57) ABSTRACT

A wireless transmit/receive unit (WTRU) may be comprised of a processor and memory. The WTRU may receive a configuration from a network that configures the WTRU to perform an inverse deep learning model. The WTRU may receive a plurality of reference signals from the network. The WTRU may determine a number of MPCs using the inverse deep learning model and based on the plurality of reference signals. The WTRU may determine an angle of arrival (AoA), an angle of departure (AoD), and a gain associated with each MPC of the number of MPC's using the inverse deep learning model and based on the plurality of reference signals. The WTRU may send an indication of the number of MPCs and the AoA, the AoD, and the gain associated with each MPC of the number of MPCs to the network.

### CROSS-REFERENCE TO RELATED APPLICATIONS

This application claims priority to U.S. Provisional Patent Application No. 63/408,919, filed Sep. 22; 2022 and U.S. Provisional Patent Application No. 63/516,637, filed Jul. 31, 2023, the entire contents of which are incorporated herein by reference in their entirety.

### BACKGROUND

In wireless communication, developing accurate signal propagation models and/or channel models that can effectively represent different environmental settings has remained a fundamental task.

The propagation characteristics of these wireless channel may be affected by several different parameters associated with the transmitter configuration (e.g., antenna spacing, carrier frequency, and/or bandwidth, etc.). Different environmental conditions may affect the multiple paths that a transmitted signal propagate through before arriving at the receiver.

### SUMMARY

A wireless transmit/receive unit (WTRU) may receive a configuration from a network that configures the WTRU to perform an inverse deep learning model. The WTRU may receive a plurality of reference signals from the network. The WTRU may determine a number of multipath components (MPCs) using the inverse deep learning model and based on the plurality of reference signals. The WTRU may determine an angle of arrival (AoA), an angle of departure (AoD), and/or a gain associated with each MPC of the number of MPCs using the inverse deep learning model and/or based on the plurality of reference signals. The WTRU may send an indication of the number of MPCs and the AoA, the AoD, and the gain associated with each MPC of the number of MPCs to the network.

The WTRU may determine a joint probability distribution function of the number of MPCs based on the number of MPCs and the AoA, the AoD, and the gain associated with each MPC of the number of MPCs. The indication of the number of MPCs and the AoA, the AoD, and the gain associated with each MPC of the number of MPCs may comprise the joint probability distribution function of the MPCs.

The WTRU may transmit the joint probability distribution function of the number of MPCs to the network and/or transmit representative parameters associated with the joint probability distribution function of the number of MPCs to the network.

The WTRU may receive an indication from the network that indicates that the WTRU is to transmit the indication of the number of MPCs and the AoA, the AoD, and/or the gain associated with each MPC of the number of MPCs to the network. The WTRU may periodically send the indication of the number of MPCs and the AoA, the AOD, and/or the gain associated with each MPC of the number of MPCs to the network. The number of MPCs and the AoA, the AoD, and/or the gain associated with each MPC of the number of MPCs may be used to train a machine learning model at the network.

The WTRU may receive an indication of a path selection method from the network. The WTRU may determine a plurality of MPCs using the inverse deep learning model and based on the plurality of reference signals. The number of MPCs may be a subset of the plurality of MPCs. The WTRU may determine the AoA, the AoD, and/or the gain associated with each of the plurality of MPCs using the inverse deep learning model and based on the plurality of reference signals. The WTRU may determine the number of MPCs out of the plurality of MPCs based on the path selection method, wherein the number of MPCs are preferred MPCs out of the plurality of MPCs.

The path selection method may comprise an energy-based method, an L1 norm method, and/or a multiple-input multiple-output (MIMO) channel rank method.

The WTRU may perform quantization, entropy encoding, and/or error correction on the AoA, the AoD, and/or the gain associated with each MPC of the number of MPCs to reduce the number of bits required to indicate the AoA, the AoD, and/or the gain associated with each MPC of the number of MPCs.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example method for channel parameter estimation for data generation.

FIG. 3 depicts an example method for CSI compression and feedback.

FIG. 4 is a flow diagram of an example end-to-end supervised learning framework.

FIG. 5 is a diagram of an example ResNet based architecture.

FIG. 6 depicts an example framework for multipath component estimation.

FIG. 7A is a plot depicting an example comparison error in Angle of Arrival/Angle of Departure estimation for an Orthogonal Matching Pursuit (OMP)-based algorithm verses a Neural Network (NN)-based framework.

FIG. 7B is a plot depicting an example inference time for estimating multipath component parameters per channel matrix for an OMP-based algorithm versus a NN-based framework.

### DETAILED DESCRIPTION

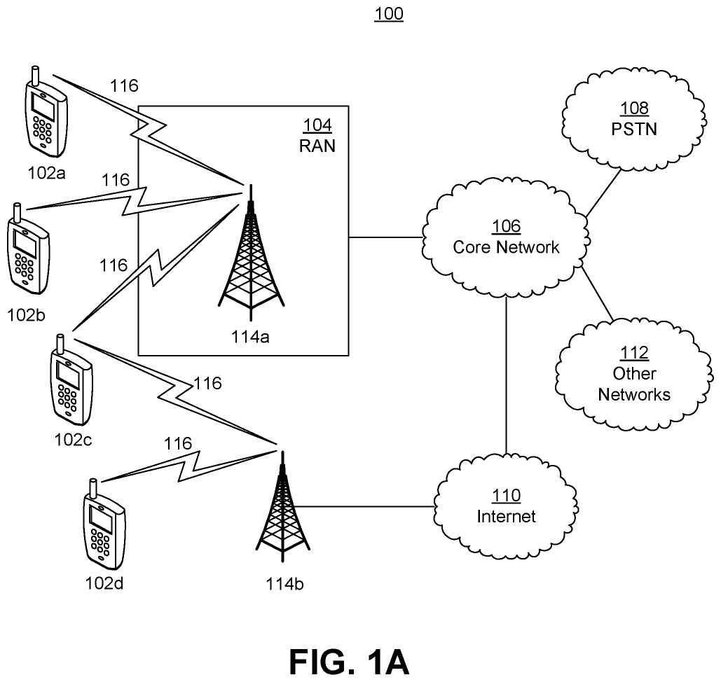

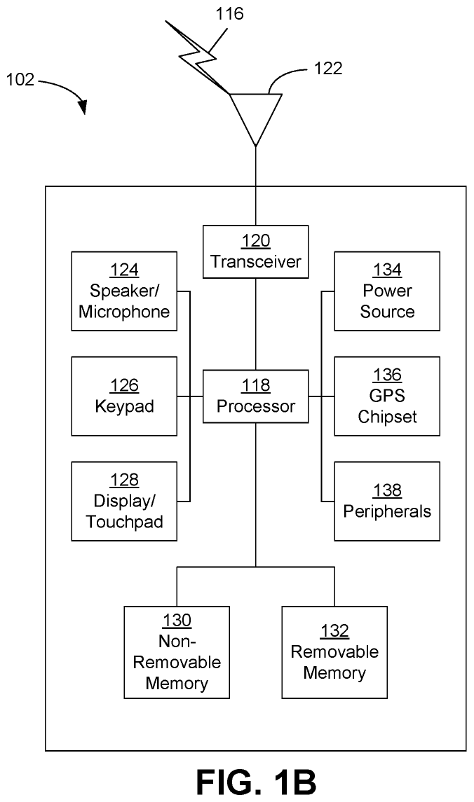

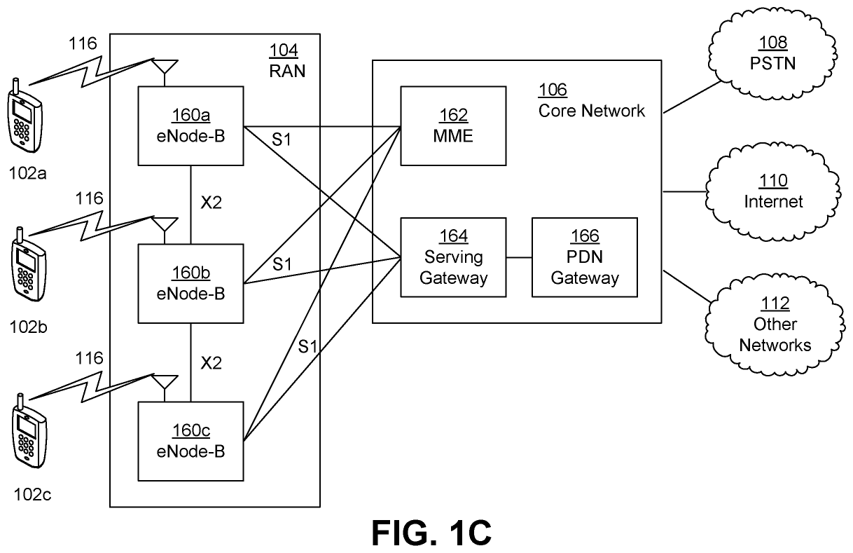

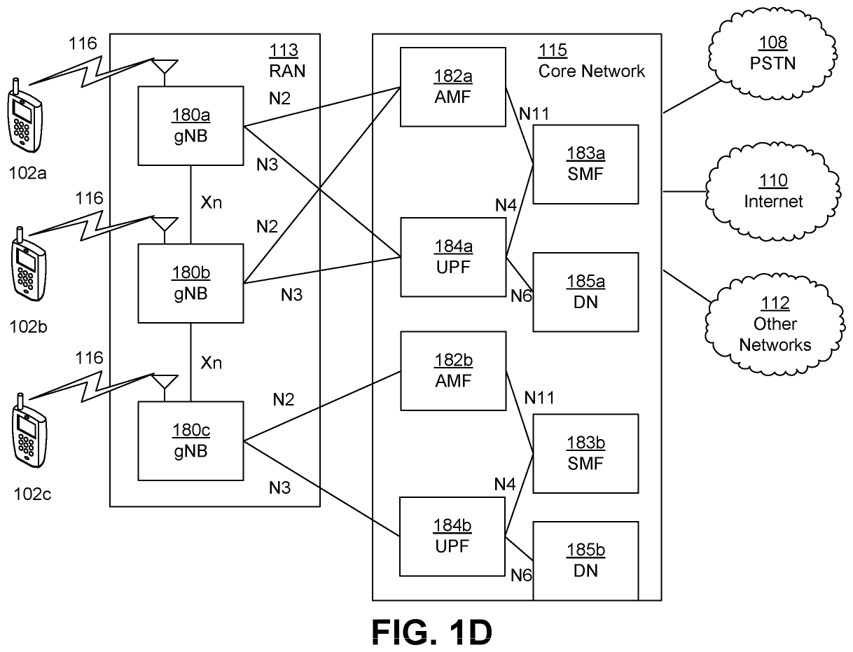

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B. Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b. 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a. 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHZ channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a. 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a. 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a. 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a. 102b. 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Channel models in varying environments may range from different indoor settings in office rooms and/or halls to multiple outdoor settings in urban and/or semi-urban environments. Different simulations tools (e.g., the COST2100 and/or NYUSIM) may allow channel simulations in these pre-defined settings. Stochastic channel models may be used (e.g., in 3GPP). Such models may use a subset of these channel models to represent a few line of sight (LOS) and/or non-line of sight (NLOS) settings for evaluation of the efficiency of the wireless communication systems.

Described herein are deep learning based inverse modeling frameworks that may be utilized for extracting the underlying multipath components from a channel matrix. Understanding such multipath components may be useful for generating simulation data that matches the characteristics of the air data collected in the field.

The methods herein describe inverse modeling of a channel to identify the parameters associated with the underlying multi-path components; how to train machine learning (ML) models for solving the inverse problem related to identifying multi-path component parameters given a raw channel matrix; and/or using the inverse modeling framework to accomplish data generation for training ML-based solutions and/or to accomplish channel state information (CSI) compression.

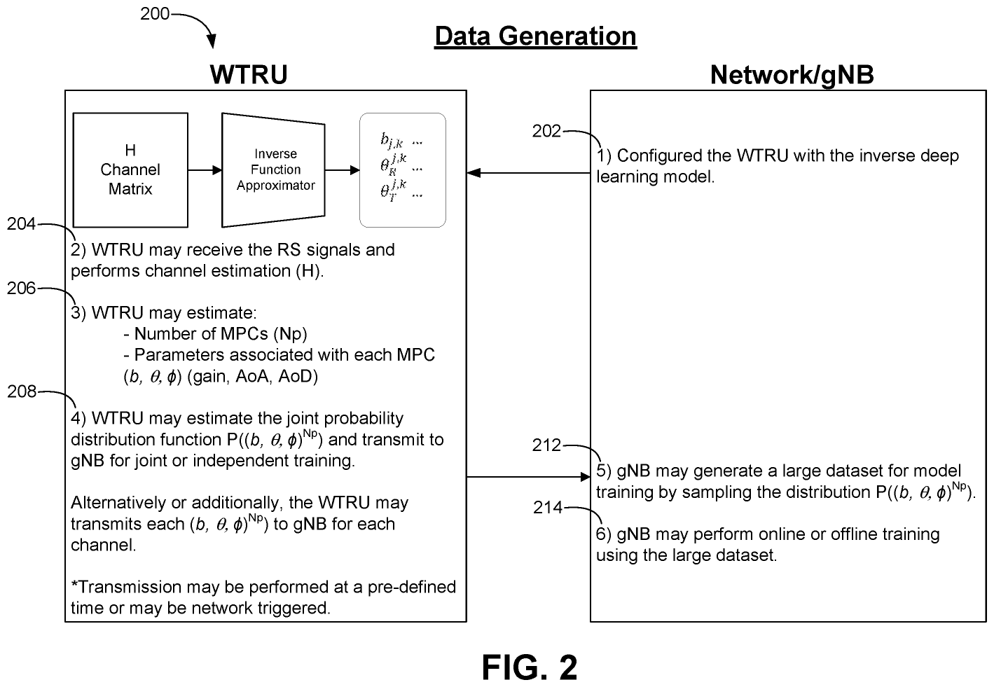

FIG. 2 depicts an example method 200 for channel parameter estimation for data generation. As depicted in FIG. 2, the method 200 described herein may be utilized both at the WTRU in a downlink (DL) communication setting and/or at the gNB in uplink (UL) communication setting. Considering the DL setting, the WTRU and/or network may be configured to perform different functions. At 202, the WTRU may receive a configuration from a network that configures the WTRU to perform an inverse deep learning model. For example, the WTRU may be configured to receive, configure, and/or utilize an inverse deep learning model (e.g., by the network). At 204, the WTRU may receive a plurality of reference signals (RSs) from the network. The RSs may be suitable for channel estimation and/or parameter estimation using the inverse deep learning model. The WTRU may perform channel estimation to estimate the multiple-input-multiple-output (MIMO) channel.

At 206, the WTRU may estimate the channel. For example, the WTRU may determine one or more the channel related parameters and properties based on the RSs and/or using the inverse deep learning model. The parameters may include any combination of a number of multi-path components (MPCs) and/or multi-path clusters, the azimuth and/or elevation angle of arrival (AoA) and/or azimuth and/or elevation angle of departure (AoD) associated with each of the MPCs and/or multi-path clusters, and/or a gain associated with each of the MPCs and/or multi-path clusters. The WTRU may send an indication of the number of MPCs and the AoA, the AoD, and the gain associated with each MPC of the number of MPCs to the network.

At 208, over time across and/or multiple channel estimates, the WTRU may further estimate the individual distributions associated with each of these parameters and/or may build a joint distribution of these parameters. For example, the WTRU may send an indication of the number of MPCs and/or the AoA, the AoD, and/or the gain associated with each MPC of the number of MPCs to the network. Alternatively or additionally, the WTRU may transmit the joint probability distribution function to the gNB. For example, the WTRU may determine a joint probability distribution function of the number of MPCs based on the number of MPCs and/or the AoA, the AoD, and/or the gain associated with each MPC of the number of MPCs, and send the joint probability distribution function to the network. If the joint distribution is modeled as a gaussian mixture model (GMM), the variances and/or means of the GMM may sufficiently represent the distribution. In some examples, the WTRU may then transmit representative parameters associated with these distributions. The WTRU may periodically send the indication of the number of MPCs and/or the AoA, the AOD, and/or the gain associated with each MPC of the number of MPCs to the network, or the WTRU may send the indication of the number of MPCs and/or the AoA, the AOD, and/or the gain associated with each MPC of the number of MPCs to the network in response to a request received from the network. The WTRU may receive an indication from the network that indicates that the WTRU is to transmit the indication of the number of MPCs and the AoA, the AoD, and the gain associated with each MPC of the number of MPCs to the network.

At 212, the gNB may sample the received joint distribution, which may allow the gNB to create valid channel data that could then be used for ML tasks. At 214, the gNB may train the model using the large dataset (e.g., online or offline). The machine learning tasks may include, but are not limited to, online and/or offline model training, model evaluation, and/or re-training triggers, etc. Additionally or alternatively, the WTRU may transmit the MPC parameters associated with each channel separately.

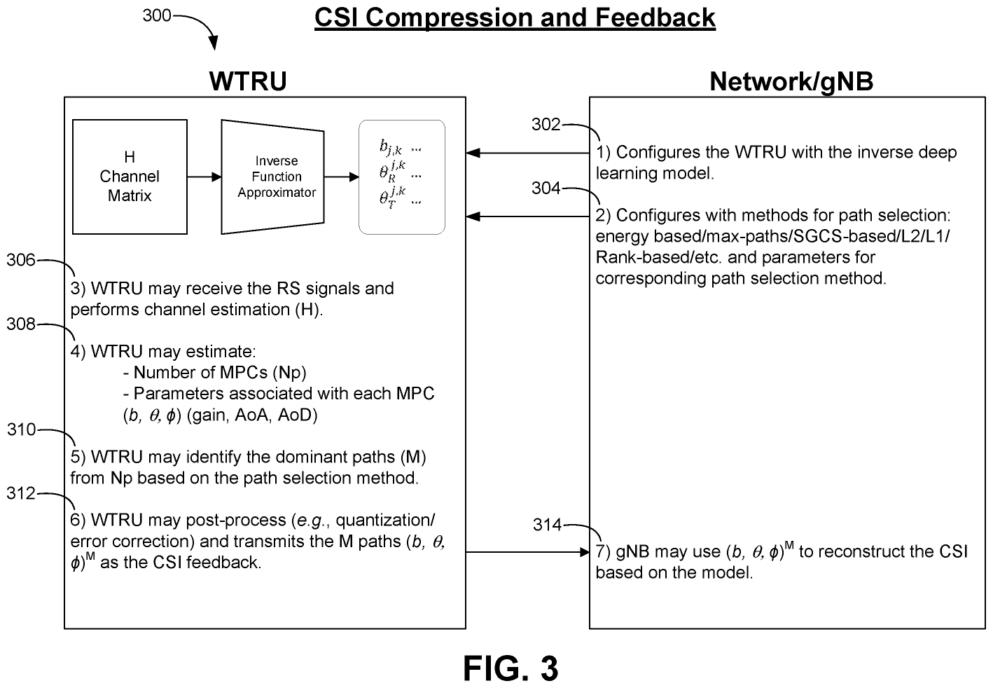

FIG. 3 depicts an example method 300 for CSI compression and feedback. As depicted in FIG. 3, the method 300 described herein may be performed by a combination of the WTRU and/or the gNB. Considering the DL setting the WTRU and/or network may be configured to perform different functions. For example, at 302, the WTRU may be configured to receive, configure, and/or utilize an inverse deep learning model. For example, the WTRU may receive a configuration from a network that configures the WTRU to perform an inverse deep learning model.

At 304, the WTRU may be configured, by the network, with one or more methods for dominant path selection. Accordingly, the WTRU may receive an indication of a path selection method from the network. For example, the WTRU may be configured with energy based dominant path selection. In this configuration, the multipaths may be ranked based on the squared value of the gain/loss associated with them. Further, the WTRU may select the paths with the largest gains whose cumulative sum is lesser than a pre-specified threshold. The WTRU may be configured with to select paths up to a threshold on a function of the multipath gains and/or losses. An example of the function maybe a Lp norm. In this configuration, the WTRU may select the multipaths up to a threshold on the Lp norm of the gains and/or losses. Where, Lp norm of a N1 dimensional vector v==[v₁, v₂, . . . , v_{N1}] is given by

$${\vert v \vert}_{p} = \sqrt[p]{{v}_{1}^{p} + {v}_{2}^{p} + ⋯ + {v}_{N 1}^{p}} .$$

Further, the WTRU may select the paths based on the cosine similarity or squared generalized cosine similarity (SGCS) of the paths, herein multiple paths with strong cosine similarity in the overall path response (or just the angles) may be combined together Paths may be considered different and/or reported individually if there existed a threshold gap in terms of cosine similarity in the overall response associated with the paths. Moreover, the WTRU configuration may be rank based (e.g., a multiple input multiple output (MIMO) channel rank method). In this configuration, the paths may be ranked based on any of the prior methods, but a subset of paths (e.g., only R paths) are selected for transmission (e.g., where R is the rank of the MIMO channel).

At 306, the WTRU may receive one or more RSs suitable for channel estimation and/or parameter estimation using inverse models. The WTRU may perform channel estimation to estimate the MIMO channel.

At 308, the WTRU may estimate the channel based on the RSs to determine channel related parameters and/or properties associated with the channel, such as, but not limited to: a number of MPCs and/or multi-path clusters; AoA and/or AoD associated with each of the MPCs or multi-path clusters; and/or a gain associated with each of the MPCs and/or multi-path clusters. For example, the WTRU may determine a number of MPCs using the inverse deep learning model and based on the plurality of RSs. The WTRU may determine an AoA, an AoD, and/or a gain associated with each MPC using the inverse deep learning model and based on the plurality of RSs. The MPCs may have all the information contained in the channel matrix. As noted herein, the WTRU may use the MPCs for CSI feedback. The WTRU may send an indication of the number of MPCs and the AoA, the AoD, and the gain associated with each MPC of the number of MPCs to the network.

At 310, the WTRU may identify a subset of paths (e.g., M dominant paths) and/or MPCs (e.g., dominate MPCs) based on the method specified for path selection (e.g. energy based, L1/Lp based, and/or rank based, etc.). The WTRU may transmit, to the network, the post-processed information corresponding to the dominant MPCs to the gNB as CSI feedback. The WTRU may periodically send the dominant MPCs as CSI feedback to the network, or the WTRU may send the dominant MPCs as CSI feedback to the network in response to a request received from the network. The dominate MPCs may include (e.g., an indication of) the AoA, the AoD, and/or the gain associated with each of the dominate MPCs.

In some examples, at 312, the WTRU may utilize post-processing methods to reduce the number of bits required to specify gains, AOA, and/or AOD corresponding to the MPCs. The post-processing methods may include, but are not limited to different forms of quantization. In examples, scalar quantization and/or vector quantization approaches may be utilized to reduce the number of bits representing each parameter. The parameters corresponding to the most dominant path(s) may be quantized with more bits. The post-processing methods may also include entropy encoding. The post-processing methods may also include error correction. Different error correction bits and/or redundancy may be added to each parameter depending on its importance.

At 314, the gNB may receive the dominant MPCs. The gNB may use the AoA, the AoD, and/or the gain associated with each dominate MPC to reconstruct the CSI using the inverse deep learning model.

The WTRU may be configured (e.g., using the using the inverse deep learning model) to identify the parameters associated with the underlying MPCs. The WTRU may be configured to identify the parameters associated with each multipath in different ways. For example, the WTRU may use MUSIC, ESPIRIT and/or SAGE for estimating the AoA and/or AoD estimation. The WTRU may be configured to determine (e.g., solve) the gain associated with the multipath as a least squares problem, for instance, after the angles are estimated using one or more of the methods described herein. The WTRU may be configured to apply an orthogonal matching pursuit (OMP) approach for simultaneous angle and gain estimation. In examples, OMP may be used as a baseline for experiments. Additionally or alternatively, tensor factorization methods may solve the parameter estimation problems.

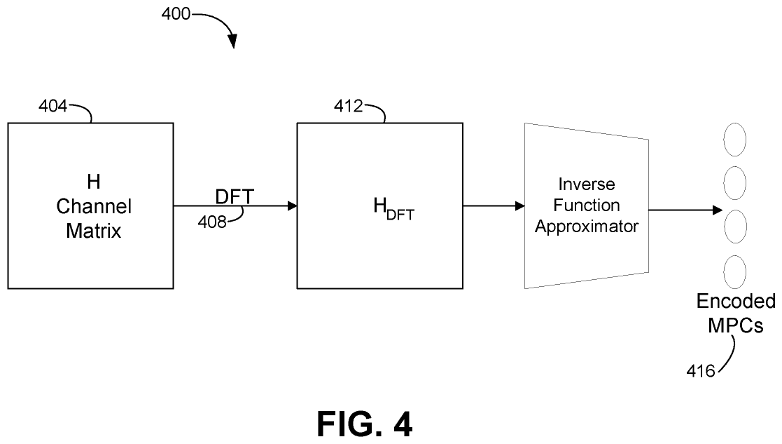

FIG. 4 depicts a flow diagram 400 of an example end-to-end supervised learning framework that may be implemented by a WTRU and/or by a network element. The WTRU may be configured to transform a channel matrix 404 using the Discrete Fourier Transform (DFT) 408. The WTRU may be configured to feed the channel matrix into a ResNet18-like architecture 412 in an end-to-end framework to generate MPC parameters 416. The flow diagram 400 depicts an end-to-end supervised learning framework to estimate multipath component parameters (MPCs) given the channel matrix that, for example, may be implemented by the WTRU.

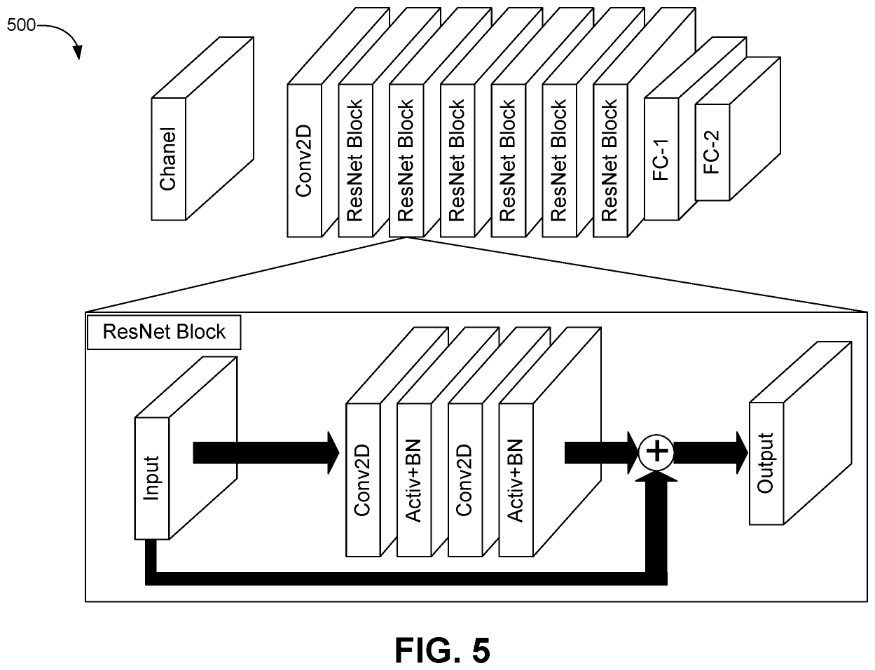

FIG. 5 illustrates an example ResNet based architecture 500. The inverse function approximator block as seen in FIG. 4 may be modelled like ResNet-18 architecture FIG. 5. The WTRU may use the mean square error between a predicted and/or ground truth multipath component parameter to train a model. The model may primarily employ residual network styled blocks and/or fully connected (FC) layers. Convolutional neural network (CNN) layers may be stacked together with Batch normalization layers, non-linear activations (like ReLu and/or LeakyReLu) and/or skip connections to form a ResNet block. Multiple ResNet blocks may be stacked with CNNs and/or FC layers to generate the architecture presented in FIG. 5.

The WTRU may be configured to apply the DFT transform on input raw channel matrices, for example, using a supervised framework. The WTRU may be configured to preprocess the channel matrices using DFT to generate a sparse representation of a channel matrix. The sparse representation of the channel matrix may provide a better estimation of AoA/AOD (e.g., as compared to an OMP-based algorithm).

The WTRU may build a dataset. For example, the WTRU may be configured to order the parameters associated with the MPCs to correspond to a given channel matrix based to the gain values of each of the multipaths. The WTRU may order the parameters associated with the MPCs because, for example, if the parameters associated with the MPCs are not ordered, the multipaths may result in a one-to-many mapping which may be difficult to learn through neural networks.

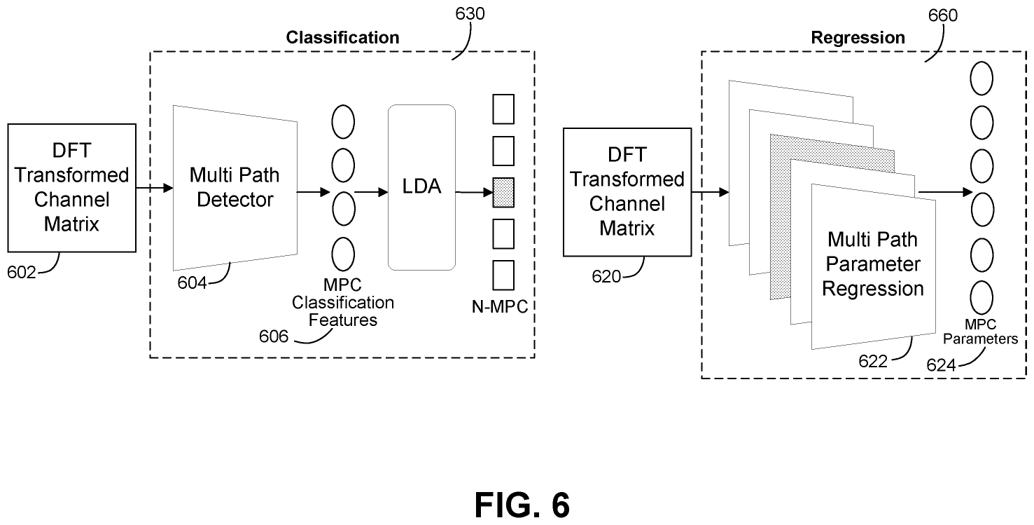

FIG. 6 depicts a framework for multipath component estimation. Moreover, FIG. 6 describes end-to-end estimation of MPC using the proposed deep learning framework. A DFT transformed channel matrix 602 may be fed to the classification model 630 to estimate the number of multipaths p, followed by Np regression models (one for each value of p) to estimate MPC parameters.

FIG. 6 shows a pictorial representation of the proposed DL based solution. Assuming a setting where a maximum of Np MPCs may be present, a classification model 630 that predicts the number of multipath components in the input channel matrix may be trained. Np different regression models 660, one for each potential number of multipath components (e.g., p) that may be encountered, may also be trained. Thus, the first regression model 660 may predict parameters explicitly for channels containing only p=1 MPC (4 predicted parameters: the real and imaginary part of the gain, AoA, and/or AoD), whereas the second model predicts parameters for channels with exactly p=2 MPCs (2 times 4 predicted parameters). The Nₚ-th model may predict Nₚ×4 parameters corresponding to channel with Nₚ multipaths. The classification 630 and/or regression 660 models may be trained using a ResNet-18 architecture.

When using a classification model 630, the MultiPath Detector (MPD) 604 head of the classification model may be trained using the end-to-end architecture, for example, as shown in FIG. 6. The input to the MPD 604 may be the 2D-DFT transformed channel matrix. Since the transformed channel may be a complex valued matrix, the real and/or imaginary matrices may be concatenated to form a R^{2×Nr×Nt} tensor. The first convolutional layer may increase the number of input dimensions at the beginning of architecture. Each ResNet block may consist of convolutional and/or batch normalization layers along with Leaky ReLu activation functions. A fully connected layer may exist towards the end of the network architecture. Since it may be assumed apriori knowledge about the maximum possible number of multipaths, Nₚ the output layer size may be fixed to Nₚ×4. To create labels for the channel matrices that have the number of paths p<Nₚ, the multipath component parameters with zero gain values and/or an out-of-range angle value may be appended. The MPD 604 using the mean square error between the ground truth and/or predicted multipath features may be trained. Next, the MPC classification features 606 from the DFT-transformed data may be generated. A supervised classification scheme (e.g., LDA and/or linear discriminant analysis]) may be utilized to estimate the number of multipaths components in the channel.

When using a regression model 660, the Nₚ multipath regression (MPR) models, one corresponding to each multipath in range [1, . . . Nₚ], may be trained. Similar to the above mentioned MPD 604 model, each of the MPR 622 models, utilize a DFT transformed channel matrices 620 regressed to the corresponding set of MPC parameters 624. Overall, Nₚ different regression models 660 may be trained, each model having a different number of output units in the final layer. The number of output units may be decided from the number of multipaths used to generate the channel matrix. In other words, the p-th model has an output layer of size 4×p (p in [1, . . . , Nₚ]).

MPC parameter estimation may be formulated as a sparse recovery problem. The WTRU may be configured to use an OMP algorithm to solve the sparse recovery problem. The WTRU may be configured to use an OMP algorithm to benchmark the performance of the proposed frameworks (e.g., a neural network (NN)-based frameworks described herein). In examples, the WTRU may use a grid of the range (e.g., [−60,60]) with a resolution of 1 degree because an OMP-based algorithm may be an exhaustive search algorithm. For the supervised framework, 70% of the data was used for training and the remaining 30% of the data was used for validation. The WTRU may test the performance of the NN-based framework and the OMP-based algorithm. For example, the WTRU may generate (e.g., randomly generate) a plurality of channel matrices (e.g., 10,000 channel matrices) using the parameters mentioned above. The WTRU may evaluate the error in AoD/AoA estimation.

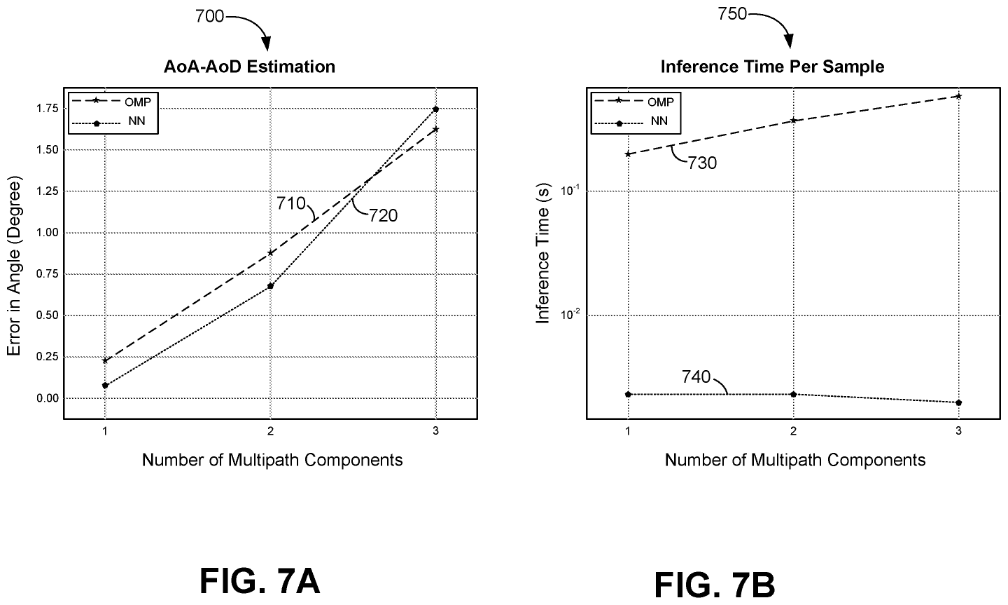

FIG. 7A is a plot 700 of an example performance comparison of an OMP-based algorithm 710 versus a NN based framework 720 for the error in angle estimation. The plot 700 of FIG. 7A depicts an example comparison error in AoD/AoA estimation for the OMP-based algorithm 710 and the NN method 720 for a varying numbers of multipath component parameters. The number of multipath component parameters in a channel matrix may increase as the error in estimation of AoA/AOD increases (e.g., as shown in FIG. 7A).

In some examples, the NN based framework 720 may outperform the OMP-based algorithm 710 when estimating the MPC parameter values when the channel matrices are composed of 1 or 2 multipath component parameters. Moreover, in some examples (e.g., for 3 multipaths), the OMP-based algorithm 710 may perform slightly better compared to the NN based framework.

FIG. 7B is a plot 750 of an example performance comparison of an OMP-based algorithm 730 versus a NN-based framework 740 for the inference time for estimating multipath component parameters per channel matrix. The plot 750 of FIG. 7B demonstrates that the inference time for a NN-based algorithm may be of the order of 100 times faster than that of an OMP-based algorithm (e.g., irrespective of the number of multipath component parameters). In examples, the OMP-based algorithm 730 may be an iterative exhaustive search algorithm. In examples, the inference time may increase as the number of multipath component parameters increases.

In examples, the WTRU may correct unsupervised AoA/AOD estimation with an encoder-decoder like architecture. The ground truth label of channel parameters or MPC parameters may be unknown (e.g., in a scenario of the OTA communication pipeline). As such, in some examples, building a supervised regression model for real OTA data may be challenging because of the unavailability of ground truth channel parameters. Accordingly, the WTRU may generate and/or implement an unsupervised encode-decoder-like model architecture. For example, the encoder part of the model may encode the channel matrix into multipath components. The decoder may be an analytical SV model that generates the channel matrices given the channel model. From the supervised framework, the WTRU may use (e.g., feed) a sparse representation of channel matrix, which for instance, may result in a better estimation of channel parameters. In the unsupervised framework, the WTRU may estimate the loss as the mean squared error loss between the ground truth channel matrix and/or predicted channel matrix generated using the SV model applied to encoded multipath parameters, for example, when applying the DFT transformed channel matrix as input.

What is claimed is:

1-18. (canceled)

19. A wireless transmit/receive unit (WTRU) comprising:
a processor and memory, the processor configured to:
receive a configuration from a network that configures the WTRU to perform an inverse deep learning model;
receive a plurality of reference signals from the network;
determine a number of multipath components (MPCs) using the inverse deep learning model and based on the plurality of reference signals;
determine an angle of arrival (AoA), an angle of departure (AoD), and a gain associated with each MPC of the number of MPCs using the inverse deep learning model and based on the plurality of reference signals; and
send an indication of the number of MPCs and the AoA, the AoD, and the gain associated with each MPC of the number of MPCs to the network.

20. The WTRU of claim 19, wherein the processor is configured to:
determine a joint probability distribution function of the number of MPCs based on the number of MPCs and the AoA, the AoD, and the gain associated with each MPC of the number of MPCs, and wherein the indication of the number of MPCs and the AoA, the AoD, and the gain associated with each MPC of the number of MPCs comprises the joint probability distribution function of the MPCs.

21. The WTRU of claim 20, wherein the processor is configured to:
transmit the joint probability distribution function of the number of MPCs to the network or transmit representative parameters associated with the joint probability distribution function of the number of MPCs to the network.

22. The WTRU of claim 19, wherein the processor is configured to:
receive an indication from the network that indicates that the WTRU is to transmit the indication of the number of MPCs and the AoA, the AoD, and the gain associated with each MPC of the number of MPCs to the network.

23. The WTRU of claim 19, wherein the processor is configured to:
periodically send the indication of the number of MPCs and the AoA, the AOD, and the gain associated with each MPC of the number of MPCs to the network.

24. The WTRU of claim 19, wherein the indication of the number of MPCs and the AoA, the AoD, and the gain associated with each MPC of the number of MPCs are used to train a machine learning model at the network.

25. The WTRU of claim 19, wherein the processor is configured to:
receive an indication of a path selection method from the network;
determine a plurality of MPCs using the inverse deep learning model and based on the plurality of reference signals, wherein the number of MPCs is a subset of the plurality of MPCs;
determine the AoA, the AoD, and the gain associated with each of the plurality of MPCs using the inverse deep learning model and based on the plurality of reference signals; and
determine the number of MPCs out of the plurality of MPCs based on the path selection method, wherein the number of MPCs are preferred MPCs out of the plurality of MPCs.

26. The WTRU of claim 19, wherein the processor is configured to:
perform quantization, entropy encoding, or error correction on the AoA, the AoD, and the gain associated with each MPC of the number of MPCs to reduce the number of bits required to indicate the AoA, the AoD, and the gain associated with each MPC of the number of MPCs.

27. The WTRU of claim 19, wherein the each of the number of MPCs comprises a plurality of paths of a multi-path transmission.

28. The WTRU of claim 19, wherein the gain indicates a propagation loss with a path of the number of MPCs.

29. A method performed by a wireless transmit/receive unit (WTRU), the method comprising:
receiving a configuration from a network that configures the WTRU to perform an inverse deep learning model;
receiving a plurality of reference signals from the network;
determining a number of multipath components (MPCs) using the inverse deep learning model and based on the plurality of reference signals;
determining an angle of arrival (AoA), an angle of departure (AoD), and a gain associated with each MPC of the number of MPCs using the inverse deep learning model and based on the plurality of reference signals; and
sending an indication of the number of MPCs and the AoA, the AoD, and the gain associated with each MPC of the number of MPCs to the network.

30. The method of claim 29, further configuring:
determining a joint probability distribution function of the number of MPCs based on the number of MPCs and the AoA, the AoD, and the gain associated with each MPC of the number of MPCs, and wherein the indication of the number of MPCs and the AoA, the AoD, and the gain associated with each MPC of the number of MPCs comprises the joint probability distribution function of the MPCs.

31. The method of claim 30, further configuring:
transmitting the joint probability distribution function of the number of MPCs to the network or transmit representative parameters associated with the joint probability distribution function of the number of MPCs to the network.

32. The method of claim 29, further configuring:
receiving an indication from the network that indicates that the WTRU is to transmit the indication of the number of MPCs and the AoA, the AoD, and the gain associated with each MPC of the number of MPCs to the network.

33. The method of claim 29, further configuring:
periodically sending the indication of the number of MPCs and the AoA, the AOD, and the gain associated with each MPC of the number of MPCs to the network.

34. The method of claim 29, wherein the indication of the number of MPCs and the AoA, the AoD, and the gain associated with each MPC of the number of MPCs are used to train a machine learning model at the network.

35. The method of claim 29, further configuring:
receiving an indication of a path selection method from the network;
determining a plurality of MPCs using the inverse deep learning model and based on the plurality of reference signals, wherein the number of MPCs is a subset of the plurality of MPCs;
determining the AoA, the AoD, and the gain associated with each of the plurality of MPCs using the inverse deep learning model and based on the plurality of reference signals; and
determining the number of MPCs out of the plurality of MPCs based on the path selection method, wherein the number of MPCs are preferred MPCs out of the plurality of MPCs.

36. The method of claim 29, further configuring:
performing quantization, entropy encoding, or error correction on the AoA, the AoD, and the gain associated with each MPC of the number of MPCs to reduce the number of bits required to indicate the AoA, the AoD, and the gain associated with each MPC of the number of MPCs.

37. The method of claim 29, wherein the each of the number of MPCs comprises a plurality of paths of a multi-path transmission.

38. The method of claim 29, wherein the gain indicates a propagation loss with a path of the number of MPCs.
